(19) United States
(12) Patent Application Publication
(10) Pub. No.: US 2012/0314002 A1
(43) Pub. Date: Dec. 13, 2012

(54) PRINTING DEVICE

(75) Inventor: Chien-Kuo Kuan, Taipei (TW)

(73) Assignee: PRIMAX ELECTRONICS LTD., Taipei (TW)

(21) Appl. No.: 13/279,476

(22) Filed: Oct. 24, 2011

(30) Foreign Application Priority Data
Jun. 10, 2011 (TW) 100120320

(51) Int. Cl. B41J 23/00

(52) U.S. Cl. 347/37

(57) ABSTRACT

A printing device includes a casing, a ribbon cartridge, a print head, a first driving motor and a second driving motor. The print head is disposed under the ribbon cartridge. A rotating center axial line of the ribbon wheel of the ribbon cartridge passes through a bottom of the casing. The print head has at least firing pin for colliding the ink ribbon, so that the ink containing in the ink ribbon is printed on a paper sheet. The first driving motor is used for driving rotation of the ribbon wheel. The second driving motor is used for driving movement of the print head between a first sidewall and a second sidewall of the casing. Consequently, the overall height and the cost of the printing device are reduced.

### FIELD OF THE INVENTION

The present invention relates to a printing device, and more particularly to an impact matrix printer.

### BACKGROUND OF THE INVENTION

In modern society, printers have become indispensable tools. The printers may be classified into a variety of types such as impact matrix printers (or dot-matrix printers), laser printers, inkjet printers or thermal transfer printers. Generally, since the dot-matrix printers are relatively cheap in fabricating cost and consumable cost, the dot-matrix printers are widely used to print invoices, receipts, vouchers or other articles.

FIG. 1 is a schematic perspective view illustrating the outward appearance of a conventional impact matrix printer. FIG. 2 is a schematic side view illustrating an inner structure including the ribbon and the print head of the impact matrix printer of FIG. 1 and taken along a viewpoint. FIG. 3 is a schematic perspective view illustrating an inner structure including the ribbon and the print head of the impact matrix printer of FIG. 1 and taken along another viewpoint. FIG. 4 is a schematic side view illustrating the inner structure of the ribbon cartridge of the impact matrix printer of FIG. 2. Please refer to FIGS. 1, 2, 3 and 4. The casing 11 of the impact matrix printer 1 has an entrance 111. Through the entrance 111, a paper sheet P1 may be introduced into the inner portion of the impact matrix printer 1 to be printed. The inner structure of the impact matrix printer 1 comprises a ribbon cartridge 12, a print head 13 and a driving motor 14 (see FIG. 5).

The ribbon cartridge 12 is fixedly installed between a first sidewall 112 and a second sidewall 113 for accommodating a long ink ribbon 121. The long ink ribbon 121 is folded to be accommodated within the ribbon cartridge 12. The ribbon cartridge 12 comprises a ribbon supply terminal 122 and a ribbon take-up terminal 123. A ribbon wheel 124 is located at the ribbon supply terminal 122. Two perforations 125 and 126 are located at the bottom of the ribbon cartridge 12. The ink ribbon 121 is allowed to be penetrated through the perforations 125 and 126. Upon rotation of the ribbon wheel 124, the ink ribbon 121a at the ribbon supply terminal 122 is driven to be ejected out of the ribbon cartridge 12 through the perforation 125. The ink ribbon 121b exposed outside the ribbon cartridge 12 is introduced into the ribbon take-up terminal 123 through the perforation 126. In other words, the ink ribbon 121 is circulated between the ribbon supply terminal 122 and the ribbon take-up terminal 123.

Moreover, the print head 13 is disposed under the ribbon cartridge 12, and movable back and forth between the first sidewall 112 and the second sidewall 113. A plurality of firing pins 131 are disposed under the print head 13 for colliding the ink ribbon 121b which is exposed outside the ribbon cartridge 12 and located between the firing pins 131 and the paper sheet P1. Consequently, the ink containing in the ink ribbon 121b can be printed on the paper sheet P1.

The source of the motive power of the conventional impact matrix printer 1 will be illustrated as follows. In the conventional impact matrix printer 1, the motive force provided by a single driving motor 14 will drive the rotation of the ribbon wheel 124 within the ribbon cartridge 12, so that the print head 13 is moved back and forth between the first sidewall 112 and the second sidewall 113. FIG. 5 schematically illustrates the transmission of the motive power in the conventional impact matrix printer of FIG. 1. As shown in FIG. 5, the driving motor 14 comprises a power shaft 141. The power shaft 141 is sheathed by and fixed on a power transmission gear 15. Consequently, as the motive power from the driving motor 14 is provided to the power shaft 141 to result in rotation of the power shaft 141, the power transmission gear 15 is synchronously rotated with the power shaft 141.

The inner portion of the conventional impact matrix printer 1 further comprises a transmission belt 16. A rack structure 161 is formed on a surface of the transmission belt 16. The rack structure 161 is engaged with the power transmission gear 15. Consequently, upon rotation of the power transmission gear 15, the transmission belt 16 is circulated or moved back and forth. Moreover, the print head 13 is connected with the transmission belt 16. As the motive power from the driving motor 14 is provided to the power shaft 141, the motive power is transmitted to the transmission belt 16 through the power transmission gear 15 and the rack structure 161, thereby driving movement of the print head 13 back and forth along the transmission belt 16.

The inner portion of the conventional impact matrix printer 1 further comprises a connection gear set 17, a ribbon driving gear 18 and a cone-shaped ribbon driving element 19. The connection gear set 17 comprises at least one plane gear. A first end of the connection gear set 17 is engaged with the power transmission gear 15. A second end of the connection gear set 17 is engaged with the ribbon driving gear 18. The larger end of the cone-shaped ribbon driving element 19 is connected with the ribbon driving gear 18, so that the ribbon driving element 19 is rotated with the ribbon driving gear 18. The tapered end of the ribbon driving element 19 is coupled with the rotating center of the ribbon wheel 124. Consequently, as the ribbon driving element 19 is rotated in a single direction, the unidirectional rotation cycle of the ribbon wheel 124 is achieved. In other words, when the motive power from the driving motor 14 is provided to the power shaft 141, the motive power can be transmitted to the ribbon wheel 124 through the power transmission gear 15, the connection gear set 17, the ribbon driving gear 18 and the ribbon driving element 19.

However, the conventional impact matrix printer 1 still has some drawbacks. For example, since the ribbon cartridge 12 is vertically located over the print head 13, the rotating center axial line 1241 of the ribbon wheel 124 within the ribbon cartridge 12 is parallel with the bottom of the casing 11 of the conventional impact matrix printer 1. Under this circumstance, the overall height of the conventional impact matrix printer 1 is increased, and thus the volume of the conventional impact matrix printer 1 is bulky. Since the general trends in electronic devices are toward small size, light weightiness and slimness, the conventional impact matrix printer 1 should be further improved.

### SUMMARY OF THE INVENTION

The present invention provides a printing device with a reduced height and reduced volume.

The present invention also provides a printing device with low fabricating cost.

In accordance with an aspect of the present invention, there is provided a printing device. The printing device includes a casing, a ribbon cartridge, a print head, a first driving motor and a second driving motor. The casing has a first sidewall, a second sidewall and a casing bottom. The ribbon cartridge is installed between the first sidewall and the second sidewall, and includes a ribbon supply terminal, a ribbon take-up terminal and an ink ribbon. A ribbon wheel is located at either the ribbon supply terminal or the ribbon take-up terminal. A rotating center axial line of the ribbon wheel passes through the casing bottom. Upon rotation of the ribbon wheel, the ink ribbon is transferred between the ribbon supply terminal and the ribbon take-up terminal. The print head is disposed under the ribbon cartridge. The print head has at least firing pin for colliding the ink ribbon, so that ink containing in the ink ribbon is printed on a paper sheet. The first driving motor is used for driving rotation of the ribbon wheel. The second driving motor is used for driving movement of the print head back and forth between the first sidewall and the second sidewall.

In an embodiment, the rotating center axial line of the ribbon wheel is perpendicular to the casing bottom.

In an embodiment, the first driving motor is a DC motor or a stepper motor.

In an embodiment, the first driving motor is a unidirectional motor.

In an embodiment, n the ribbon cartridge has a ribbon wheel gear. The ribbon wheel gear and the ribbon wheel have a common shaft, so that the ribbon wheel is rotated with the ribbon wheel gear.

In an embodiment, the first driving motor includes a first power shaft with a worm gear, and the worm gear is engaged with the ribbon wheel gear. When a motive power is provided to the first power shaft by the first driving motor, the motive power is transmitted to the ribbon wheel gear through the worm gear, thereby driving rotation of the ribbon wheel.

In an embodiment, the second driving motor is a stepper motor or a DC motor.

In an embodiment, the second driving motor is a bidirectional motor.

In an embodiment, the second driving motor further includes a second power shaft, which is sheathed by a power transmission gear. The power transmission gear is fixed on the second power shaft and engaged with a rack structure of a transmission belt. The print head is connected to the transmission belt. When a motive power is provided to the second power shaft by the second driving motor, the motive power is transmitted to the transmission belt through the power transmission gear and the rack structure, thereby driving movement of the print head along the transmission belt.

In an embodiment, the ink ribbon is transferred and circulated between the ribbon supply terminal and the ribbon take-up terminal.

In an embodiment, a center axial line of the first driving motor is not parallel with a center axial line of the second driving motor.

In an embodiment, a center axial line of the first driving motor is perpendicular to a center axial line of the second driving motor.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional impact matrix printer;

FIG. 2 is a schematic side view illustrating an inner structure including the ribbon and the print head of the impact matrix printer of FIG. 1 and taken along a viewpoint;

FIG. 3 is a schematic perspective view illustrating an inner structure including the ribbon and the print head of the impact matrix printer of FIG. 1 and taken along another viewpoint;

FIG. 4 is a schematic side view illustrating the inner structure of the ribbon cartridge of the impact matrix printer of FIG. 2;

FIG. 5 schematically illustrates the transmission of the motive power in the conventional impact matrix printer of FIG. 1;

FIG. 6 is a schematic perspective view illustrating the outward appearance of a printing device according to an embodiment of the present invention;

FIG. 7 is a schematic side view illustrating an inner structure of the printing device of FIG. 6 and taken along a viewpoint;

FIG. 8 is a schematic perspective view illustrating an inner structure of the printing device of FIG. 6 and taken along another viewpoint;

FIG. 9A is a schematic top view illustrating the inner structure of the ribbon cartridge of the printing device of FIG. 6;

FIG. 9B is a schematic bottom view illustrating the inner structure of the ribbon cartridge of the printing device of FIG. 6;

FIG. 10 schematically illustrates the transmission of the motive power in the printing device according to an embodiment of the present invention; and

FIG. 11 schematically illustrates the transmission of the motive power in the printing device according to another embodiment of the present invention.

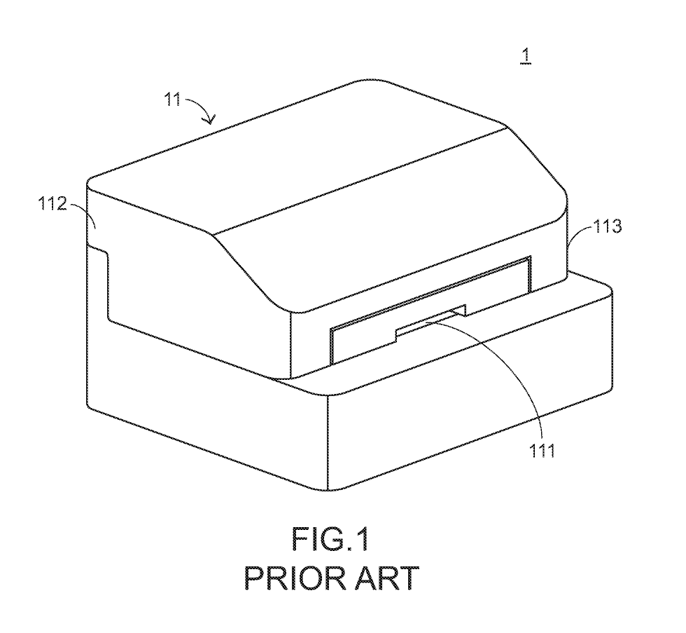

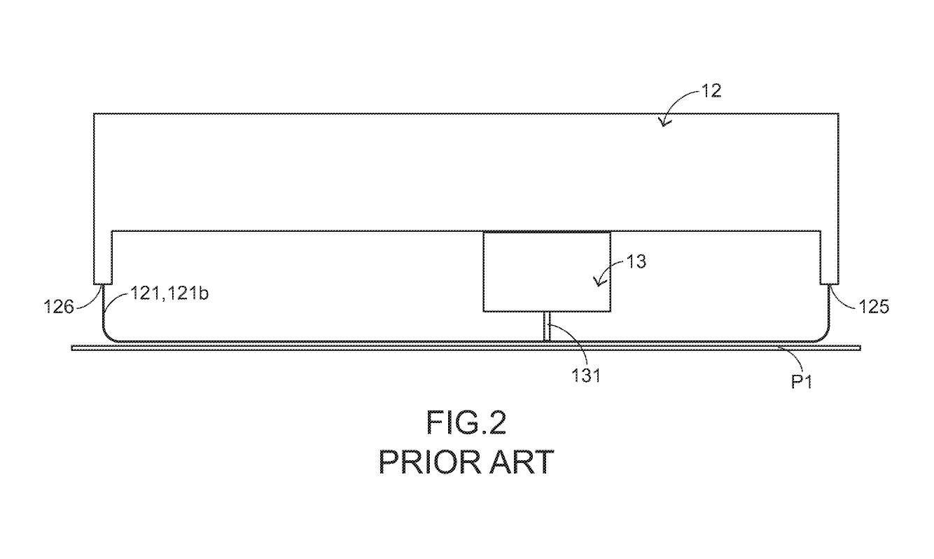

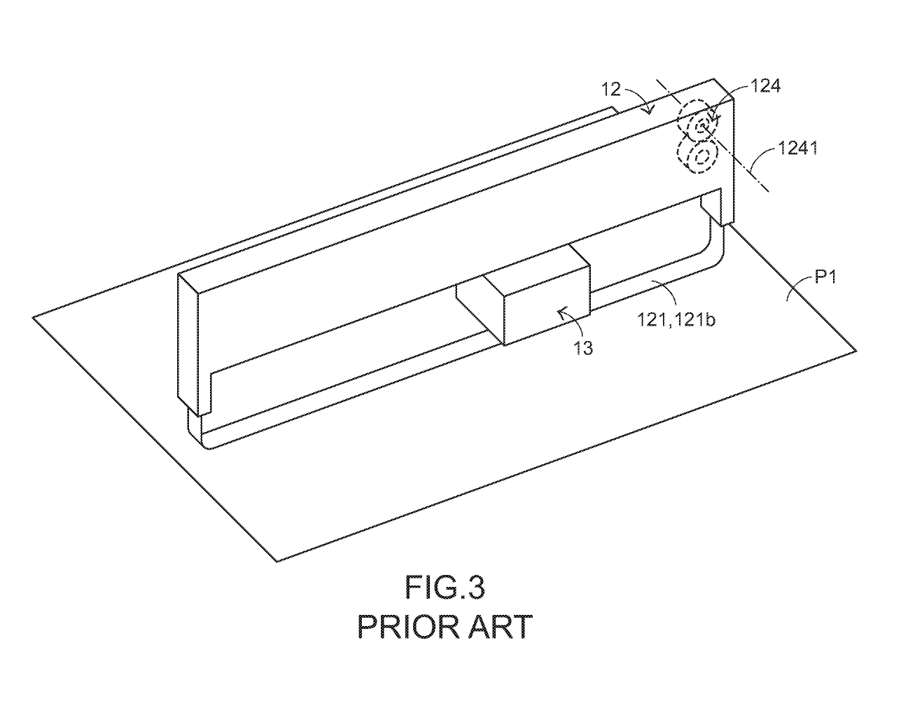

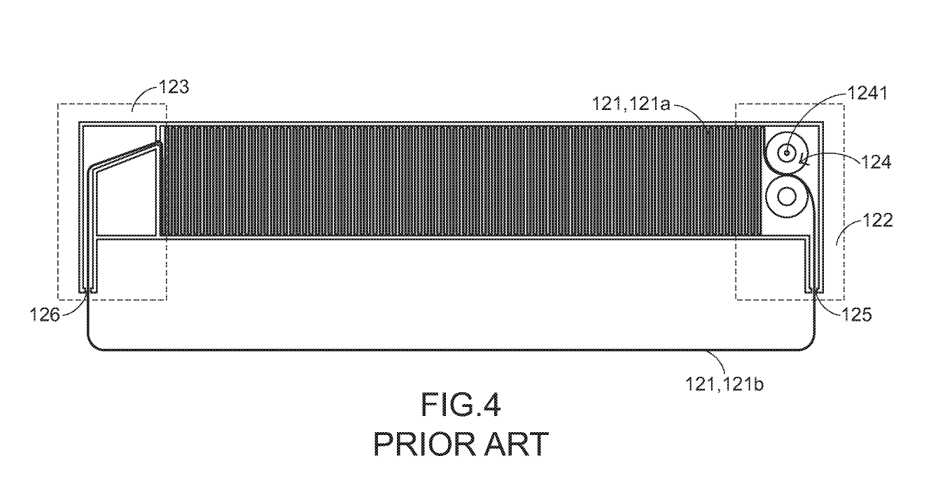

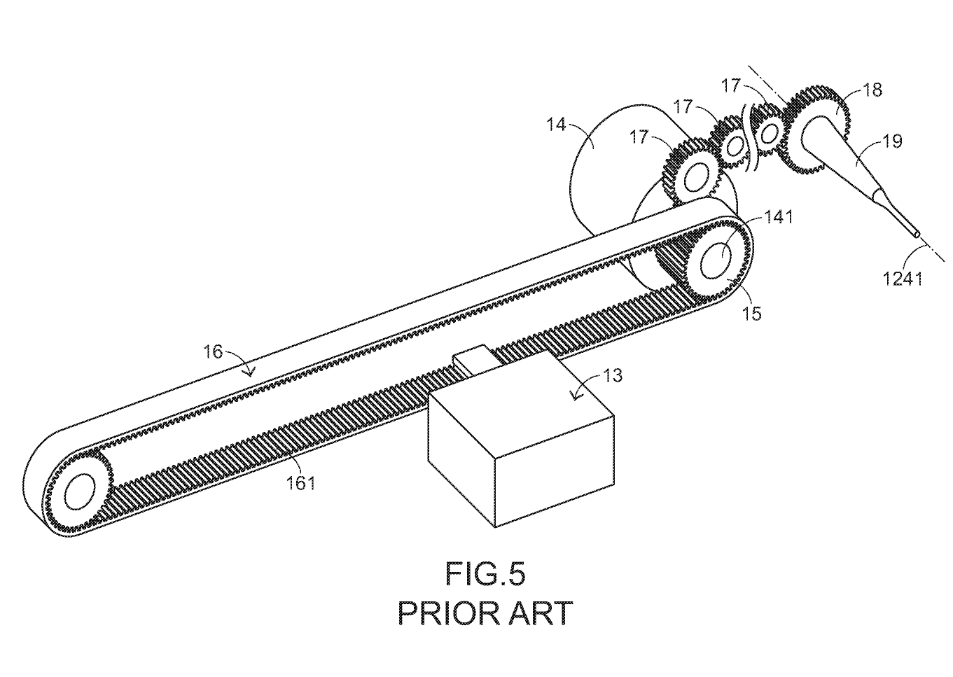

### DETAILED DESCRIPTION OF THE PREFERRED EMBODIMENT

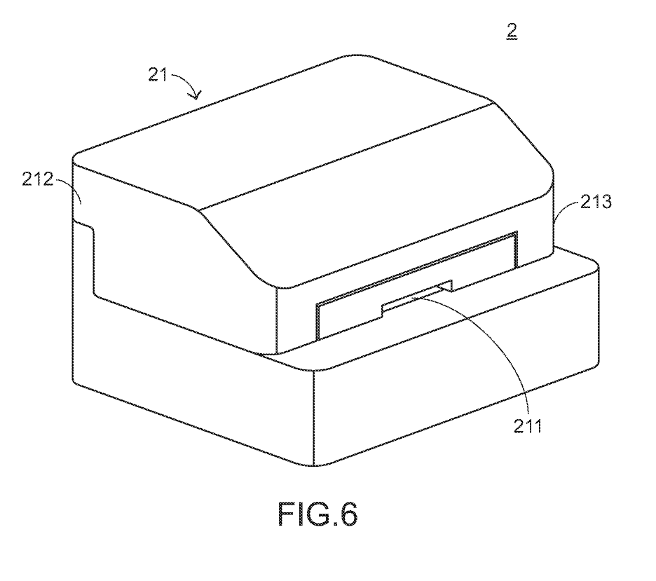

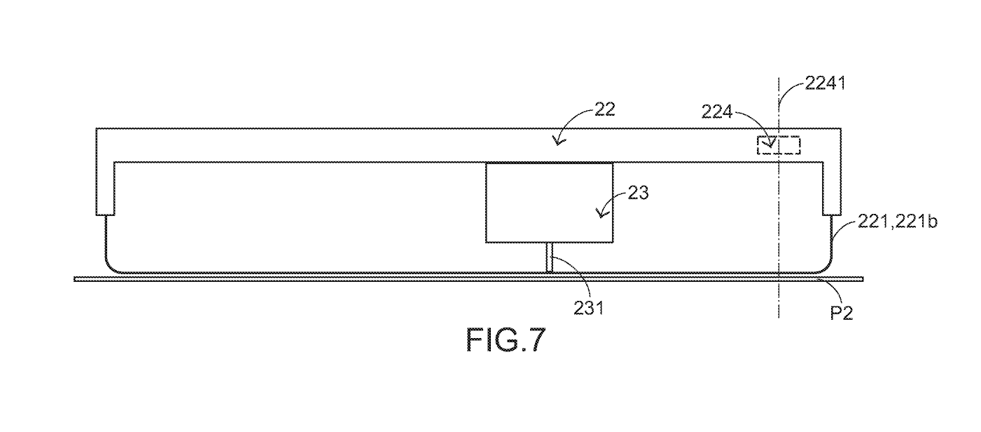

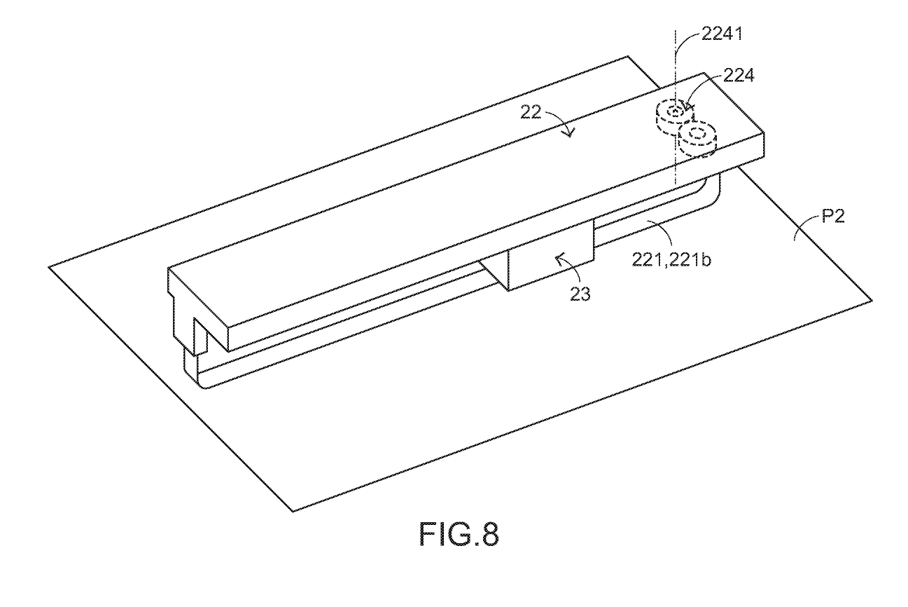

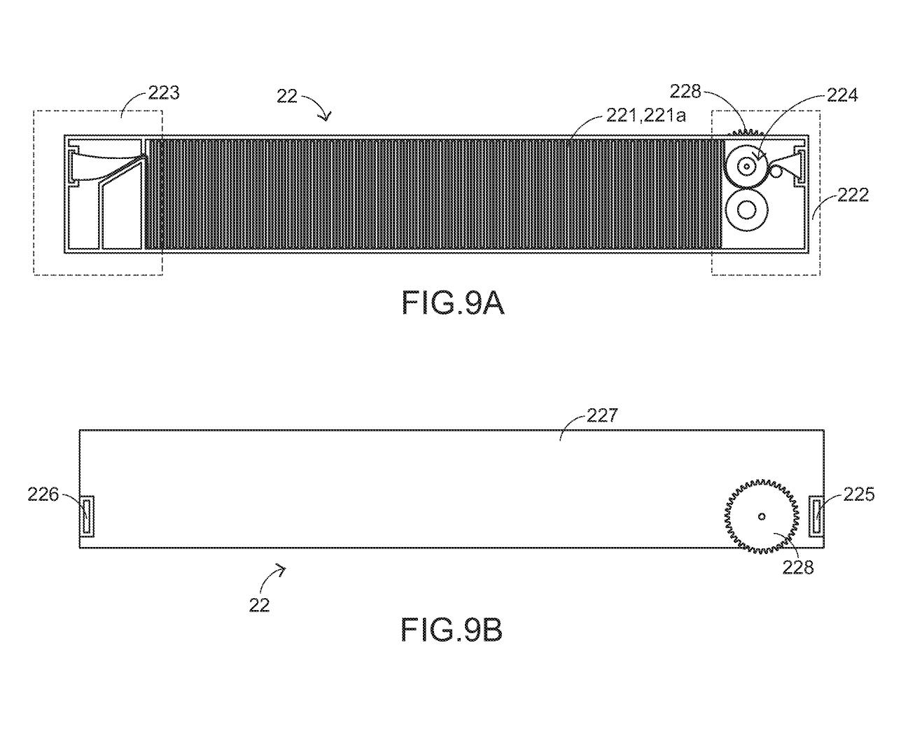

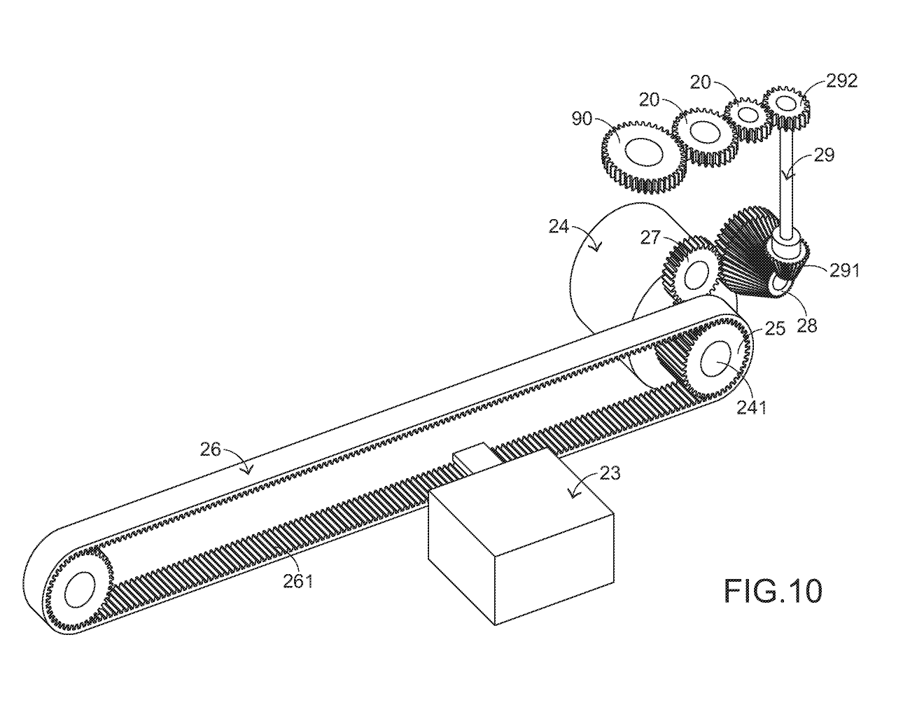

FIG. 6 is a schematic perspective view illustrating the outward appearance of a printing device according to an embodiment of the present invention. FIG. 7 is a schematic side view illustrating an inner structure of the printing device of FIG. 6 and taken along a viewpoint. FIG. 8 is a schematic perspective view illustrating an inner structure of the printing device of FIG. 6 and taken along another viewpoint. FIG. 9A is a schematic top view illustrating the inner structure of the ribbon cartridge of the printing device of FIG. 6. FIG. 9B is a schematic bottom view illustrating the inner structure of the ribbon cartridge of the printing device of FIG. 6. Please refer to FIGS. 6, 7, 8, 9A and 9B. The casing 21 of the printing device 2 has an entrance 211. Through the entrance 211, a paper sheet P2 may be introduced into the inner portion of the printing device 2 to be printed. The inner structure of the printing device 2 comprises a ribbon cartridge 22, a print head 23 and a driving motor 24 (see FIG. 10).

The ribbon cartridge 22 is fixedly installed between a first sidewall 212 and a second sidewall 213 for accommodating a long ink ribbon 221. The ribbon cartridge 22 comprises a ribbon supply terminal 222 and a ribbon take-up terminal 223. A ribbon wheel 224 is located at the ribbon supply terminal 222. Two perforations 225 and 226 are located at the bottom of the ribbon cartridge 22. An ink ribbon 221 is allowed to be penetrated through the perforations 225 and 226.

Moreover, the ink ribbon 221a within the ribbon cartridge 22 is folded in a stacking arrangement. Upon rotation of the ribbon wheel 224, the ink ribbon 221a at the ribbon supply terminal 222 is driven to be ejected out of the ribbon cartridge 22 through the perforation 225. The ink ribbon 221b exposed outside the ribbon cartridge 22 is introduced into the ribbon take-up terminal 223 through the perforation 226. In other words, the ink ribbon 221 is circulated between the ribbon supply terminal 222 and the ribbon take-up terminal 223. In addition, a ribbon wheel gear 228 is located at a casing bottom 227 of the ribbon cartridge 22. The ribbon wheel gear 228 and the ribbon wheel 224 have a common shaft, so that the ribbon wheel 224 is rotated with the ribbon wheel gear 228.

Moreover, the print head 23 is disposed under the ribbon cartridge 22, and movable back and forth between the first sidewall 212 and the second sidewall 213. At least one firing pin 131 is disposed under the print head 23 for colliding the ink ribbon 221b which is exposed outside the ribbon cartridge 22 and located between the firing pin 231 and the paper sheet P2. Consequently, the ink containing in the ink ribbon 221b can be printed on the paper sheet P2.

Especially, since the ribbon cartridge 22 is not vertically located over the print head 23, the rotating center axial line 2241 of the ribbon wheel 224 within the ribbon cartridge 22 passes through the bottom of the casing 21 of the printing device 2. In this embodiment, the rotating center axial line 2241 of the ribbon wheel 224 is perpendicular to the bottom of the casing 21 of the printing device 2. In such way, the overall height and volume of the printing device 2 can be effectively reduced.

The source of the motive power of the printing device 2 will be illustrated as follows. In the printing device 2, the motive force provided by the same single driving motor will drive rotation of the ribbon wheel 224 within the ribbon cartridge 22, so that the print head 23 is moved back and forth between the first sidewall 212 and the second sidewall 213. FIG. 10 schematically illustrates the transmission of the motive power in the printing device according to an embodiment of the present invention. As shown in FIG. 10, the driving motor 24 comprises a power shaft 241. The power shaft 241 is sheathed by and fixed on a power transmission gear 25. Consequently, as the motive power from the driving motor 24 is provided to the power shaft 241 to result in rotation of the power shaft 241, the power transmission gear 25 is synchronously rotated with the power shaft 241.

The inner portion of the printing device further comprises a transmission belt 26. A rack structure 261 is formed on a surface of the transmission belt 26. The rack structure 261 is engaged with the power transmission gear 25. Consequently, upon rotation of the power transmission gear 25, the transmission belt 26 is moved back and forth. Moreover, the print head 23 is connected with the transmission belt 26. As the motive power from the driving motor 24 is provided to the power shaft 241, the motive power is transmitted to the transmission belt 26 through the power transmission gear 25 and the rack structure 261, thereby driving movement of the print head 23 along the transmission belt 26. Moreover, since the print head 23 should be precisely positioned during the process of moving the print head 23 to implement the printing operation of the printing device 2, it is preferred that the driving motor 24 is a bidirectional stepper motor.

Moreover, since the rotating center axial line 2241 of the ribbon wheel 224 is perpendicular to the bottom of the casing 21 of the printing device 2, the rotating direction of the ribbon wheel 224 is also perpendicular to the rotating direction of the power shaft 241 of the driving motor 24. Under this circumstance, the motive power from the driving motor 24 fails to be transmitted to the ribbon wheel 224 through the simple plane gears.

For effectively transmitting the motive power to the ribbon wheel 224, the printing device 2 of the present invention further comprises a first connection gear set 27, a bevel gear 28, a bevel gear shaft 29, a second connection gear set 20 and a ribbon wheel driving gear 90. The first connection gear set 27 comprises at least one plane gear or at least one two-layered gear. A first end of the first connection gear set 27 is engaged with the power transmission gear 25. A second end of the first connection gear set 27 is engaged with the bevel gear 28. Another bevel gear 291 is formed at a first end of the bevel gear shaft 29 and engaged with the bevel gear 28. A plane transmission gear 292 is formed at a second end of the bevel gear shaft 29. Moreover, the second connection gear set 20 comprises at least one plane gear or at least one two-layered gear. A first end of the second connection gear set 20 is engaged with the plane transmission gear 292 of the bevel gear shaft 29. A second end of the second connection gear set 20 is engaged with the ribbon wheel driving gear 90. The ribbon wheel driving gear 90 is also engaged with the ribbon wheel gear 228 (not shown in FIG. 10, please refer to FIG. 9B). Consequently, when the motive power from the driving motor 24 is provided to the power shaft 241, the motive power can be transmitted to the ribbon wheel gear 228 through the power transmission gear 25, the first connection gear set 27, the bevel gear 28, the bevel gear shaft 29, the second connection gear set 20 and the ribbon wheel driving gear 90, thereby driving rotation of the ribbon wheel 224. It is noted that numerous modifications may be made while retaining the teachings of the invention. For example, through a combination of various spatial gear mechanisms, the motive power provided by the driving motor 24 can be transmitted to the ribbon wheel 224.

Since the ink ribbon 221 is very long, the ink ribbon 221a within the ribbon cartridge 22 should be closely stacked on each other. Under this circumstance, a large rotation torque is required to rotate the ribbon wheel 224 so as to drive circulation of the ink ribbon 221 between the ribbon supply terminal 222 and the ribbon take-up terminal 223. However, for providing a larger rotation torque, it is necessary to increase the volume and the fabricating cost of the bidirectional stepper motor. Therefore, there is a need of providing an improved power transmission mechanism to obviate the above drawbacks.

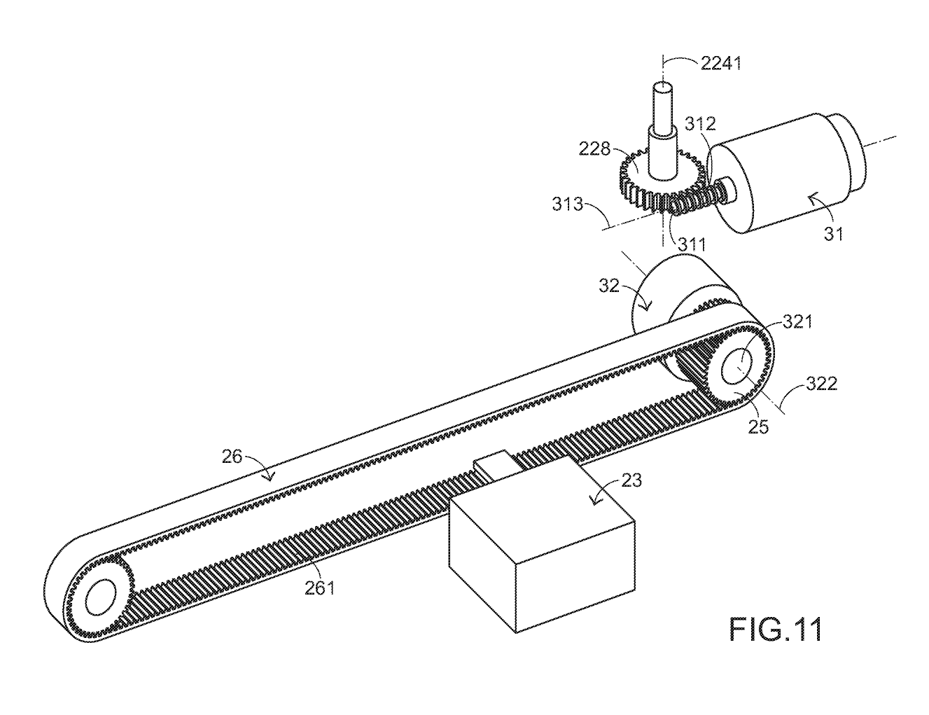

FIG. 11 schematically illustrates the transmission of the motive power in the printing device according to another embodiment of the present invention. In this embodiment, the printing device 2 comprises a first driving motor 31 and a second driving motor 32. The first driving motor 31 is used for driving rotation of the ribbon wheel 224 within the ribbon cartridge 22. The second driving motor 32 is used for driving movement of the print head 23 back and forth between the first sidewall 212 and the second sidewall 213. In other words, the ribbon wheel 224 and the print head 23 are driven by different motive power sources. Moreover, the center axial line 313 of the first driving motor 31 is perpendicular to the center axial line 322 of the second driving motor 32.

The relationship between the second driving motor 32 and the print head 23 in this embodiment is similar to that of the first embodiment, and is not redundantly described herein. As the motive power from the second driving motor 32 is provided to a second power shaft 321, the motive power is transmitted to the transmission belt 26 through the power transmission gear 25 and the rack structure 261, thereby driving movement of the print head 23 along the transmission belt 26. The mechanism of transmitting the motive power to the transmission belt 26 is similar to those illustrated in the first embodiment, and are not redundantly described herein. Moreover, since the print head 23 should be precisely positioned during the process of moving the print head 23 to implement the printing operation of the printing device 2, an example of the second driving motor 32 is a bidirectional stepper motor. However, the only purpose of the second driving motor 32 of this embodiment is to drive movement of the print head 23 without the need of providing a large rotation torque to the ribbon wheel 224. Consequently, the loading of the second driving motor 32 is largely reduced, and the volume of the second driving motor 32 is reduced. In other words, the volume of the printing device 2 is minimized.

On the other hand, the only purpose of the first driving motor 31 of this embodiment is to provide a large rotation torque without the need of precisely rotating the ribbon wheel 224 within the ribbon cartridge 22. In views of cost-effectiveness, an example of the first driving motor 31 is a general unidirectional DC motor. In a preferred driving mechanism, the first driving motor 31 comprises a first power shaft 311. A worm gear 312 is formed on the first power shaft 311. The worm gear 312 is engaged with the ribbon wheel gear 228. Consequently, as the motive power from the first driving motor 31 is provided to the first power shaft 311, the motive power is transmitted to the ribbon wheel gear 228 through the worm gear 312, thereby driving rotation of the ribbon wheel 224. It is noted that numerous modifications of the driving structure and the driving mechanism may be made while retaining the teachings of the invention.

In this embodiment, since the rotation of the ribbon wheel 224 is driven by the unidirectional DC motor, the first driving motor 31 is relatively cost-effective. Especially, the total cost of the first driving motor 31 and the second driving motor 32 is less than the cost of using a single stepper motor (i.e. in the first embodiment or the prior art technology).

From the above description, the printing device of the present invention employs simple plane gears to transmit the motive power without the complicated spatial gear mechanism. As a consequence, the inner structure of the printing device is effectively simplified.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printing device, comprising:
a casing having a first sidewall, a second sidewall and a casing bottom;
a ribbon cartridge installed between said first sidewall and said second sidewall, and comprising a ribbon supply terminal, a ribbon take-up terminal and an ink ribbon, wherein a ribbon wheel is located at either said ribbon supply terminal or said ribbon take-up terminal, and a rotating center axial line of said ribbon wheel passes through said casing bottom, wherein upon rotation of said ribbon wheel, said ink ribbon is transferred between said ribbon supply terminal and said ribbon take-up terminal;
a print head disposed under said ribbon cartridge, wherein said print head has at least firing pin for colliding said ink ribbon, so that ink containing in said ink ribbon is printed on a paper sheet;
a first driving motor for driving rotation of said ribbon wheel; and
a second driving motor for driving movement of said print head back and forth between said first sidewall and said second sidewall.

2. The printing device according to claim 1 wherein said rotating center axial line of said ribbon wheel is perpendicular to said casing bottom.

3. The printing device according to claim 1 wherein said first driving motor is a DC motor or a stepper motor.

4. The printing device according to claim 1 wherein said first driving motor is a unidirectional motor.

5. The printing device according to claim 1 wherein said ribbon cartridge has a ribbon wheel gear, wherein said ribbon wheel gear and said ribbon wheel have a common shaft, so that said ribbon wheel is rotated with said ribbon wheel gear.

6. The printing device according to claim 5 wherein said first driving motor comprises a first power shaft with a worm gear, and said worm gear is engaged with said ribbon wheel gear, wherein when a motive power is provided to said first power shaft by said first driving motor, said motive power is transmitted to said ribbon wheel gear through said worm gear, thereby driving rotation of said ribbon wheel.

7. The printing device according to claim 1 wherein said second driving motor is a stepper motor or a DC motor.

8. The printing device according to claim 1 wherein said second driving motor is a bidirectional motor.

9. The printing device according to claim 1 wherein said second driving motor further comprises a second power shaft, which is sheathed by a power transmission gear, wherein said power transmission gear is fixed on said second power shaft and engaged with a rack structure of a transmission belt, and said print head is connected to said transmission belt, wherein when a motive power is provided to said second power shaft by said second driving motor, said motive power is transmitted to said transmission belt through said power transmission gear and said rack structure, thereby driving movement of said print head along said transmission belt.

10. The printing device according to claim 1 wherein said ink ribbon is transferred and circulated between said ribbon supply terminal and said ribbon take-up terminal.

11. The printing device according to claim 1 wherein a center axial line of said first driving motor is not parallel with a center axial line of said second driving motor.

12. The printing device according to claim 1 wherein a center axial line of said first driving motor is perpendicular to a center axial line of said second driving motor.
